(19) United States
(12) Patent Application Publication
(10) Pub. No.: US 2024/0128881 A1
(43) Pub. Date: Apr. 18, 2024

(54) POWER SUPPLY CONTROL CIRCUIT, A POWER SUPPLY CONTROL METHOD, AND A FLYBACK SWITCHING POWER SUPPLY

(71) Applicant: Shenzhen Kiwi Instruments Corporation, Shenzhen (CN)

(72) Inventors: Xiufeng YU, Shenzhen (CN); Guanqiu LIN, Shenzhen (CN); Jianping LIAO, Shenzhen (CN)

(21) Appl. No.: 18/516,912

(22) Filed: Nov. 21, 2023

(30) Foreign Application Priority Data
Nov. 22, 2022 (CN) 202211464006.5

(51) Int. Cl. H02M 3/335

(52) U.S. Cl. CPC H02M 3/33569

(57) ABSTRACT

The application discloses a power supply control circuit, a power supply control method, and a flyback switching power supply. The power supply control circuit is configured to power a wide voltage output circuit, having an input terminal coupled to an input voltage, having an output terminal configured to output a power supply voltage. The power supply control circuit comprises a boost circuit, the boost circuit comprising a first switch tube and a switch control circuit, the switch control circuit coupled to a control terminal of the first switch tube. The switch control circuit is configured to control the first switch tube to start switching action when the input voltage is less than a preset voltage, and configured to control the first switch tube to stop switching action when the input voltage is greater than the preset voltage. The switch control circuit comprises a charge and discharge circuit, a first comparison circuit and a trigger circuit. The application discloses a power supply control circuit, a power supply control method, and a flyback switching power supply, which can reduce the voltage withstanding of chip devices, thereby reducing chip cost, and realize stable switching of system between full load state and light load state.

### CROSS-REFERENCE TO RELATED APPLICATIONS

This application claims priority to and the benefit of Chinese Patent Applications No. 202211464006.5, filed on Nov. 22, 2022, which are incorporated herein by reference in its entirety.

### TECHNICAL FIELD

This application relates to the power electronics technical field, to a power supply technology, and in particular, to a power supply control circuit, a power supply control method, and a flyback switching power supply.

### BACKGROUND

Compared with the forward switching power supply, the flyback switching power supply is widely used in occasions of low power and multiple output, because of it having advantages of relatively simple circuit, relatively small volume, and higher modulation amplitude of output voltage subject to duty ratio. The flyback switching power supply comprises a transformer winding, a primary side circuit and a secondary side circuit.

In the application circuit of flyback switching power supply with wide voltage output, as is shown in FIG. 1, since the output voltage of flyback switching power supply supports a wide range of voltage output from 3.3V to 21V, considering that operating voltage VDD of chips is not less than 9V, usually according to the output voltage change ratio, setting auxiliary winding Vaux voltage range of 10V to 80V, for operating voltage VDD of chips being in a reasonable working range, usually using external or internal low voltage difference linear voltage regulator circuit LDO to realize voltage drop so that the operating voltage VDD of chips can reach the requirement of 12V. To improve circuit integration, the low voltage difference linear voltage regulator circuit LDO needs to be built into chips. However, due to high voltage required by the low voltage difference linear voltage regulator circuit built into chips, the cost of chips is higher.

In view of this, it is necessary to provide a new structure or control method for solving at least some of the above problems.

### SUMMARY

In view of one or more problems in the prior art, a power supply control circuit, a power supply control method, and a flyback switching power supply is provided in the present application.

A power supply control circuit, configured to power a wide voltage output circuit, having an input terminal coupled to an input voltage, having an output terminal configured to output a power supply voltage, the power supply control circuit comprising a boost circuit, the boost circuit comprising a first switch tube and a switch control circuit, the switch control circuit coupled to a control terminal of the first switch tube; the switch control circuit configured to control the first switch tube to start switching action when the input voltage is less than a preset voltage, and configured to control the first switch tube to stop switching action when the input voltage is greater than the preset voltage; the switch control circuit comprising:

a charge and discharge circuit, having a first input terminal coupled to the preset voltage, having a second input terminal coupled to the input voltage, having an output terminal to output a charge and discharge voltage, configured to adjust the charge current during charge and discharge process according to the preset voltage and the power supply voltage to control the charge and discharge voltage;

a first comparison circuit, having a first input terminal coupled to the charge and discharge voltage, having a second input terminal coupled to a feedback signal characterizing the input voltage; and

a trigger circuit, having a set terminal coupled to the output terminal of the first comparison circuit, configured to generate a drive signal to control the first switch tube.

Another embodiment of the present application discloses a flyback switching power supply, comprising a primary side circuit, a secondary side circuit and a transformer winding, and the primary side circuit comprising the power supply control circuit as described above.

Yet another embodiment of the present application discloses a power supply control method, configured to control a power supply control circuit, the power supply control circuit comprising a boost circuit, the boost circuit comprising a first switch tube and a switch control circuit, the switch control circuit coupled to the control terminal of the first switch tube; the switch control circuit configured to control the first switch tube to start switching action when the input voltage is less than a preset voltage, and configured to control the first switch tube to stop switching action when the input voltage is greater than the preset voltage; the switch control circuit comprising a charge and discharge circuit and a first comparison circuit; the power supply control method comprising:

adjusting the charge current during charge and discharge process according to the preset voltage and the power supply voltage to control a charge and discharge voltage;

comparing the charge and discharge voltage with a feedback signal characterizing the input voltage, then outputting a comparison result signal; and

generating a driver signal to control the first switch tube according to the comparison result signal.

### BRIEF DESCRIPTION OF THE DRAWINGS

The above aspects and implementation forms of the present application will be explained in the following description of specific embodiments in relation to the enclosed drawings, in which

FIG. 1 shows a schematic diagram of a circuit structure of a prior art flyback switching power supply;

FIG. 2 shows a schematic diagram of a circuit structure of a flyback switching power supply according to an embodiment of the present application;

FIG. 3 shows a schematic diagram of a circuit structure of a boost circuit according to an embodiment of the present application;

FIG. 4 shows a schematic diagram of a circuit structure of a power supply control circuit according to an embodiment of the present application;

FIG. 5 shows a schematic diagram of a circuit structure of a power supply control circuit according to another embodiment of the present application.

### DETAILED DESCRIPTION

In order to further understand the present application, the following describes the preferred implementation scheme of the application in combination with embodiments, but it should be understood that these descriptions only for further illustrate the features and advantages of the present application, rather than limit the claims of the present application.

The descriptions in this section is only for a few typical embodiments, and the present application is not limited to the scope of the description of the embodiments. Combinations of different embodiments, replacement of some technical features in different embodiments, and replacement of same or similar prior art means with some technical features in the embodiments are also within the scope of description and protection of the present application.

“Coupling” or “connection” in the specification includes both direct connection and indirect connection. Indirect connection is a connection through an intermediate medium, such as a connection through an electrically conductive medium such as a conductor, wherein the electrically conductive medium may contain parasitic inductance or parasitic capacitance, and may also be connected through an intermediate circuit or component described in the embodiments in the specification; indirect connections may also include connections through other active or passive devices on the basis of which the same or similar functions can be achieved, such as connections through switches, signal amplifiers, follower circuits and other circuits or components. “Multiple” or “many” means two or more. In addition, in the present application, terms such as first and second are used primarily to distinguish one technical feature from another and do not necessarily require or imply an actual relationship or sequence between these technical features.

An embodiment of the present application is disclosed a power supply control circuit, The power supply control circuit configured to power a wide voltage output circuit, having an input terminal coupled to an input voltage, having an output terminal configured to output a power supply voltage. The power supply control circuit comprises a boost circuit, the boost circuit comprising a first switch tube and a switch control circuit, the switch control circuit coupled to a control terminal of the first switch tube. The switch control circuit is configured to control the first switch tube to start switching action when the input voltage is less than a preset voltage, and configured to control the first switch tube to stop switching action when the input voltage is greater than the preset voltage. The first switch tube starts switching action, including two states, namely on state and off state. The wide voltage output circuit can output the output voltage within a preset range to meet the output voltage requirements of different loads. In one example, the wide voltage output circuit can provide an output voltage of 3.3V to 21V.

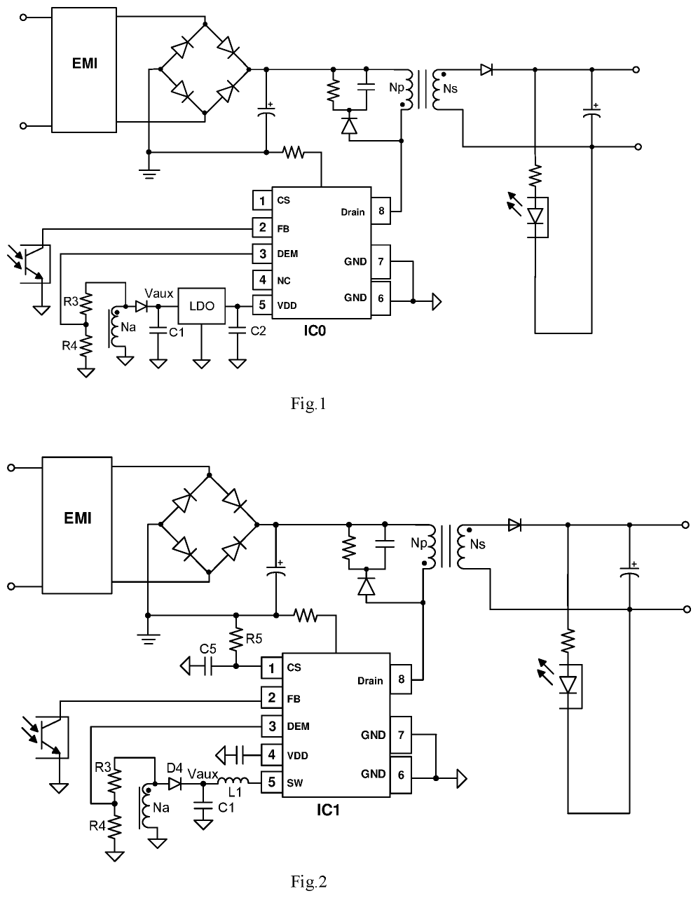

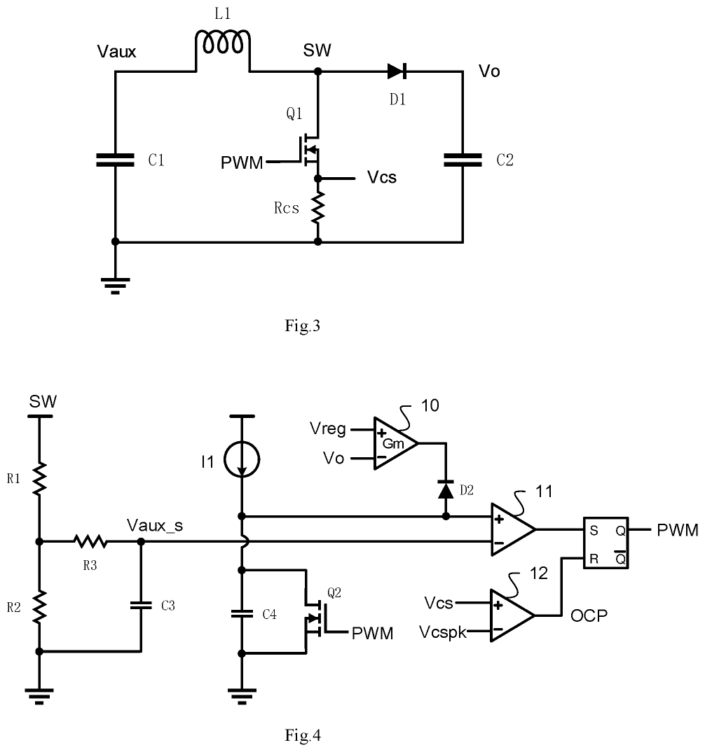

Combined with FIGS. 2 and 3, an embodiment of the application discloses a flyback switching power supply, the flyback switching power supply comprising a transformer winding, a primary side circuit and a secondary side circuit. the primary side circuit comprises a primary side switch tube and a primary side control circuit, the primary side control circuit comprising the power supply control circuit. The transformer winding comprises a primary side winding Np, a secondary side winding Ns and a auxiliary winding Na. The power supply control circuit comprising the boost circuit, has an input terminal coupled to the input voltage Vaux, and has an output terminal configured to output the power supply voltage Vo. the power supply voltage Vo is configured to power the chip IC1. As shown in FIG. 2, the chip IC1 is provided with a SW pin, and the SW pin is coupled to the first inductor L1.

As shown in FIG. 3, in an embodiment of the application, the boost circuit comprises a first inductor L1, a first diode D1, a first switch tube Q1 and a second capacitor C2. the first inductor L1 has a first terminal coupled to the input voltage Vaux, and the first diode D1 has an anode coupled to a second terminal of the first inductor L1, and the second capacitor C2 has a first terminal coupled to the cathode of the first diode D1, and the second capacitor C2 has a second terminal coupled to ground, and the first terminal of the second capacitor C2 outputs the supply voltage Vo. The first switch tube Q1 has a control terminal coupled to the output terminal of the switch control circuit to obtain the drive signal, and the first switch tube Q1 has a first terminal coupled to the second terminal of the first inductor L1, and the first switch tube Q1 has a second terminal coupled to ground. In another embodiment, the boost circuit further comprises a first capacitor C1, and the first capacitor C1 has a first terminal coupled to the first terminal of the first inductor L1, and the first capacitor C1 has a second terminal coupled to ground. Preferably, the boost circuit further comprises a sampling resistance Rcs, and the sampling resistance Rcs has a first terminal coupled to the second terminal of the first switch tube Q1, and the sampling resistance Rcs has a second terminal coupled to ground, and the voltage Vcs at first terminal of the sampling resistance Rcs can be configured as a current sampling signal.

In one embodiment, as shown in FIG. 2, the power supply control circuit further comprises a auxiliary winding Na and a fourth diode D4, and the fourth diode has an anode coupled to the auxiliary winding Na, and the fourth diode D4 has a cathode coupled to the input terminal of the boost circuit.

In one embodiment of the application, the switch control circuit comprises a charge and discharge circuit, a first comparison circuit and a trigger circuit. The charge and discharge circuit comprises a charge and discharge control circuit and a fourth capacitor. The charge and discharge control circuit is configured to control charge and discharge of the fourth capacitor. The charge and discharge control circuit has a first input terminal and a second input terminal, the first input terminal of the charge and discharge control circuit coupled to the preset voltage, the second input terminal of the charge and discharge control circuit coupled to the power supply voltage, the charge and discharge control circuit according to the preset voltage and the power supply voltage to adjust the charge current of the charge and discharge circuit during charge and discharge process, so that the charge and discharge circuit outputs the charge and discharge voltage. The first comparison circuit has a first input terminal, a second input terminal and an output terminal. The first input terminal of the first comparison circuit is coupled to the charge and discharge voltage, and the second input terminal of the first comparison circuit is coupled to a feedback signal characterizing the input voltage. The trigger circuit has a set terminal coupled to the output terminal of the first comparison circuit, and the trigger circuit is configured to generate the driver signal PWM to control state of the first switch tube.

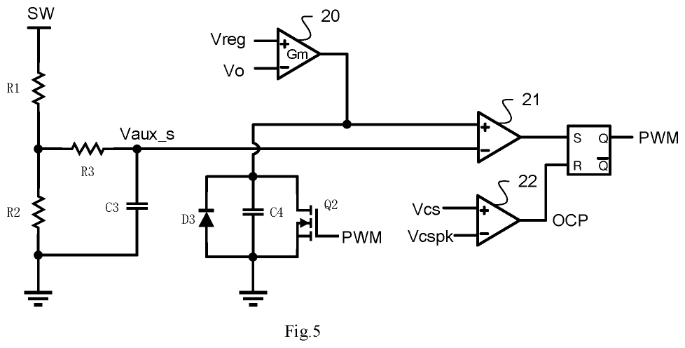

As shown in FIG. 4, in another embodiment of the application, the switch control circuit comprises a charge and discharge circuit, a first comparison circuit 11 and a trigger circuit. The charge and discharge circuit comprises a current source I1, a fourth capacitor C4, a second switch tube Q2, a transconductance amplifier circuit 10 and a second diode D2. The current source I1 is configured to provide the first current. The fourth capacitor C4 has a first terminal coupled to the output terminal of the current source I1, and the fourth capacitor C4 has a second terminal coupled to ground, and the first terminal of the fourth capacitor C4 is configured to output the charge and discharge voltage. The second switch tube Q2 has a control terminal, a first terminal and a second terminal, and the control terminal of the second switch tube Q2 is coupled to the drive signal PWM, and the first terminal of the second switch tube Q2 is coupled to the first terminal of the fourth capacitor C4, and the second terminal of the second switch tube Q2 is coupled to the second terminal of the fourth capacitor C4. The first terminal of the transconductance amplifier circuit 10 is coupled to the preset voltage Vreg, and the second terminal of the transconductance amplifier circuit 10 is coupled to the supply voltage Vo. The transconductance amplifier circuit 10 is configured to output a transconductive current according to the preset voltage Vreg and the supply voltage Vo. The anode of the second diode D2 is coupled to the first terminal of the fourth capacitor C4, and the cathode of the second diode D2 is coupled to the output terminal of the transconductance amplifier circuit 10. In one embodiment, the transconductance amplifier circuit 10 comprises a transconductance amplifier, and the non-inverting input of the transconductance amplifier is coupled to the preset voltage Vreg, and the inverting input terminal of the transconductance amplifier is coupled to the supply voltage Vo, and the output terminal of the transconductance amplifier outputs the transconductive current. As shown in FIG. 4, the first comparison circuit 11 comprises a first comparator, and the non-inverting input terminal of the first comparator is coupled to the charge and discharge voltage, and the inverting input terminal of the first comparator is coupled to the feedback signal characterizing the input voltage, and the output terminal of the first comparator is coupled to the set terminal of the trigger circuit. In this embodiment, the feedback signal Vaux_s is obtained after the input voltage Vaux is partialized and filtered.

In another embodiment of the application, the switch control circuit further comprises a feedback signal generation circuit, the feedback signal generation circuit comprising a first resistor R1, a second resistor R2, a third resistor R3, and a third capacitor C3. The first terminal of the first resistor R1 is coupled to the SW pin, as can be seen from FIG. 3, and the first terminal of the first resistor R1 is further coupled to the input voltage Vaux through the first inductor L1. The first terminal of the second resistor R2 is coupled to the second terminal of the first resistor R1, and the second terminal of the second resistor R2 is coupled to ground. The first terminal of the third resistor R3 is coupled to the second terminal of the first resistor R1. The first terminal of the third capacitor C3 is coupled to the second terminal of the third resistor R3, and the second terminal of the third capacitor C3 is coupled to the second terminal of the second resistor R2.

In another embodiment of the application, as shown in FIG. 4, the switch control circuit further comprises a second comparison circuit 12, and the first input terminal of the second comparison circuit 12 is coupled to the current sampling signal Vcs, and the second input terminal of the second comparison circuit 12 is coupled to the peak current sampling reference voltage Vcspk, and the output terminal of the second comparison circuit 12 is coupled to the reset terminal of the trigger circuit. In an embodiment, the second comparison circuit 12 comprises a second comparator, the non-inverting input terminal of the second comparator is coupled to the current sampling signal Vcs, and the inverting input terminal of the second comparator is coupled to the peak current sampling reference voltage Vcspk, and the output terminal of the second comparator is coupled to the reset terminal of the trigger circuit.

In an embodiment shown in FIG. 2 to FIG. 4, the switch control circuit is configured to control the first switch tube Q1 to start switching action when the input voltage Vaux is less than the preset voltage Vreg, and the supply voltage Vo is equal to the preset voltage Vreg. The switch control circuit is further configured to control the first switch tube Q1 to stop switching action when the input voltage Vaux is greater than the preset voltage Vreg. The input voltage Vaux is directly transmitted to the second capacitor C2 through the first inductor L1 and the first diode D1, and the voltage drop of the first inductor L1 and the first diode D1 can be ignored, at the moment, the supply voltage Vo being equal to the input voltage Vaux.

Combined with an embodiment of FIG. 4, the switch control circuit is coupled to the SW pin, after the voltage of the SW pin is processed by the partial voltage of the first resistor R1 and the second resistor R2, then filtered by the third resistor R3 and the third capacitor C3 to obtain a smooth voltage signal Vaux_s. The voltage signal Vaux_s is a representative signal of the input voltage. According to the inductive volt-second balance principle, the average voltage of the SW pin voltage is equal to Vaux, that is, Vaux_s=Vaux*R2/(R1+R2). In this embodiment, the turn-off time Toff of the first switch tube in the boost circuit is proportional to the voltage signal Vaux_s, that is, Toff=Vaux_s*C4/I1. When the boost circuit works in heavy load continuous mode, Vaux*Ton=(VREG−VAUX)*Toff is met, thus the switching period Ts of the first switch tube is: Ts=Ton+Toff=Vreg*R2*C4/(R1+R2)/I1. Wherein, I1 is the output current of the current source I1, and C4 is the capacitance value of the fourth capacitor, and Ton is the open time of the first switch tube, and R1 is the resistance value of the first resistor, and R2 is the resistance value of the second resistor, and Vreg is the preset voltage. According to the formula Ts=Vreg*R2*C4/(R1+R2)/I1, all parameters on the right side of the above equation are fixed parameters of the chip, so the switch period Ts is basically close to stability. The power supply control circuit of the application can realize the effect of close to fixed frequency. Because the turn-off time Toff is controlled in the application, the power supply control circuit of the application does not need to carry out slope compensation like the conventional PWM control system, and simplifies the design of the system.

In addition, when the boost circuit switches to light load mode, the load is reduced and the corresponding supply voltage Vo will rise. As shown in FIG. 4, the second diode D2 will flow current, the charge current of the fourth capacitor C4 will be decreased, then the switch period of the first switch tube Q1 Ts=Vreg*R2*C4/(R1+R2)/(I1−(Vo−Vreg)*gm). When switching to light load, the switch period Ts of the first switch tube Q1 will be increased, thus achieving reduced frequency control. When I1=(Vo−Vreg)*gm, the switch period Ts will be infinite, that is, stop driving the first switch tube Q1. The output current I1 of the current source I1 and the gm value of the transconductance amplifier circuit can be selected according to the load adjustment rate requirements of the supply voltage Vo. The control architecture of the power supply control circuit in the application is simple and easy to stabilize, and after the input voltage Vaux rises to the preset voltage, the boost circuit can make a smooth transition from closed loop operation to stop drive easily.

As shown in FIG. 5, in one embodiment of the application, the switch control circuit comprises a charge and discharge circuit, a first comparison circuit 21, and a trigger circuit. The charge and discharge circuit comprises a transconductance amplifier circuit 20, a fourth capacitor C4, a third diode D3 and a second switch tube Q2. The first terminal of the transconductance amplifier circuit 20 is coupled to the preset voltage Vreg, and the second terminal of the transconductance amplifier circuit 20 is coupled to the supply voltage Vo. The first terminal of the fourth capacitor C4 is coupled to the output terminal of the transconductance amplifier circuit 20, and the second terminal of the fourth capacitor C4 is coupled to ground. The anode of the third diode D3 is coupled to the second terminal of the fourth capacitor C4, and the cathode of the third diode D3 is coupled to the first terminal of the fourth capacitor C4. The second switch tube Q2 has a control terminal, a first terminal and a second terminal, and the control terminal of the second switch tube Q2 is coupled to the drive signal PWM, and the first terminal of the second switch tube Q2 is coupled to the first terminal of the fourth capacitor C4, and the second terminal of the second switch tube Q2 is coupled to the second terminal of the fourth capacitor C4. The switch control circuit may further comprise a second comparison circuit 22, and the first input terminal of the second comparison circuit 22 is coupled to the current sampling signal Vcs, and the second input terminal of the second comparison circuit 22 is coupled to the peak current sampling reference voltage Vcspk, and the output terminal of the second comparison circuit 22 is coupled to the reset terminal of the trigger circuit. In an embodiment shown in FIG. 5, the charge and discharge circuit further comprises a maximum current limiting circuit coupled between the transconductance amplifier circuit and the fourth capacitor, the maximum current limiting circuit configured to control the charge current of the fourth capacitor so that the charge current does not exceed the preset current.

In combination with an embodiment of FIG. 5, the transconductance amplifier circuit outputs a charge current valuing (Vreg−Vo)*gm and limits (Vreg−Vo)*gm to a maximum value of I1. Then the switch period of the first switch tube Q1 is Ts=Vreg*R2*C4/(R1+R2)/((VREG−vo)*gm), then when Vo=Vreg, the output of the transconductive amplifier circuit is 0, and the switch period Ts of the first switch tube Q1 is infinite, that is, the drive stops. When Vo<Vreg, the shortest switch period (corresponding to the highest frequency) is Ts=Vreg*R2*C4/(R1+R2)/I1. According to the above formula, when the supply voltage Vo deviates from the preset voltage Vreg, the switch period of the first switch tube Q1 is smaller. When the supply voltage Vo is close to the preset voltage Vreg, the switch period of the first switch tube Q1 is larger.

In an embodiment of the application, the first switch tube Q1 may be one of a metal-oxide-semiconductor field-effect transistor, junction field-effect transistor, insulated gate bipolar transistor, etc. for an example, Taking the first switch tube Q1 as a metal-oxide-semiconductor field-effect transistor, the gate coupling of the first switch tube Q1 is coupled to the output terminal of the control circuit, and the drain coupling of the first switch tube Q1 is coupled to the second terminal of the first inductor, and the source coupling of the first switch tube Q1 is coupled to ground. Similarly, the second switch tube Q2 can also be a metal-oxide-semiconductor field-effect transistor, junction field-effect transistor, insulated gate bipolar transistor and other transistors.

Another embodiment of the present application discloses a flyback switching power supply, comprising a primary side circuit, a secondary side circuit and a transformer winding, and the primary side circuit comprising the power supply control circuit as described above.

Yet another embodiment of the present application discloses a power supply control method, configured to control the power supply control circuit, the power supply control circuit comprising a boost circuit, the boost circuit comprising a first switch tube and a switch control circuit, the switch control circuit coupled to a control terminal of the first switch tube; the switch control circuit configured to control the first switch tube to start switching action when the input voltage is less than preset voltage, and configured to control the first switch tube to stop switching action when the input voltage is greater than the preset voltage; the switch control circuit comprising a charge and discharge circuit and a first comparison circuit; the power supply control method comprising: adjusting the charge current during charge and discharge process according to the preset voltage and the power supply voltage to control charge and discharge voltage; comparing the charge and discharge voltage with a feedback signal characterizing the input voltage, then outputting a comparison result signal; and generating a driver signal to control the first switch tube according to the comparison result signal. In one specific embodiment, the switch control circuit controls the first switch tube to start switching action when the input voltage is less than the preset voltage, and controls the first switch tube to stop switching action when the input voltage is greater than the preset voltage, so that the supply voltage is not lower than the minimum supply voltage when the wide voltage output circuit is working normally.

In one embodiment of the application, the charge and discharge circuit comprises a current source, a fourth capacitance and a transconductance amplifier circuit, the fourth capacitance coupled to the current source, an output terminal of the transconductance amplifier circuit coupled to the current source and the fourth capacitance, wherein the power supply control method further comprises: when the supply voltage is greater than the preset voltage, a first current output from the current source is allowed to be diverted to the transconductance amplifier circuit, and when the supply voltage is less than the preset voltage, the output current from the transconductance amplifier circuit is cut off.

The field technician should know, specification or drawings of the logic control of the “high level” and “low level”, “setting” and “reset”, “and gate” and “or gate”, “non-inverting input” and “inverting input” logic control can exchange each other or change, such as by adjusting the subsequent logic control and the implementation and the implementation of the same function or purpose.

The description and application of the present application herein is illustrative and is not intended to limit the scope of the present application to the above embodiments. The description of effects or advantages involved in the specification may not be reflected in actual experimental cases due to the uncertainty of specific condition parameters or other factors, and the description of effects or advantages shall not be used to limit the scope of the application. Variations and alterations of embodiments disclosed herein are possible and the substitutions and equivalent components of embodiments are known to those ordinary technicians in the field. It should be clear to those skilled in the field that the application may be realized in other forms, structures, arrangements, proportions, and with other components, materials and components, without deviating from the spirit or essential characteristics of the application. Other variations and alterations may be made to the embodiments disclosed herein without leaving the scope and spirit of the application.

I/we claim:

1. A power supply control circuit, configured to power a wide voltage output circuit, having an input terminal coupled to an input voltage, having an output terminal configured to output a power supply voltage, the power supply control circuit comprising a boost circuit, the boost circuit comprising a first switch tube and a switch control circuit, the switch control circuit coupled to a control terminal of the first switch tube; the switch control circuit configured to control the first switch tube to start switching action when the input voltage is less than a preset voltage, and configured to control the first switch tube to stop switching action when the input voltage is greater than the preset voltage; the switch control circuit comprising:
a charge and discharge circuit, having a first input terminal coupled to the preset voltage, having a second input terminal coupled to the input voltage, having an output terminal to output a charge and discharge voltage, configured to adjust the charge current during charge and discharge process according to the preset voltage and the power supply voltage to control the charge and discharge voltage;
a first comparison circuit, having a first input terminal coupled to the charge and discharge voltage, having a second input terminal coupled to a feedback signal characterizing the input voltage; and
a trigger circuit, having a set terminal coupled to the output terminal of the first comparison circuit, configured to generate a drive signal to control the first switch tube.

2. The power supply control circuit according to claim 1, wherein the power supply control circuit further comprises an auxiliary winding and a fourth diode, the anode of the fourth diode coupled to the auxiliary winding, and the cathode of the fourth diode coupled to the input terminal of the boost circuit.

3. The power supply control circuit according to claim 1, wherein the power supply control circuit further comprises a feedback signal generation circuit, the feedback signal generation circuit comprising:
a first resistor, having a first terminal coupled to the input voltage;
a second resistor, having a first terminal coupled to the second terminal of the first resistor, having a second terminal coupled to ground;
a third resistor, having a first terminal coupled to the second terminal of the first resistor; and
a third capacitance, having a first terminal coupled to the second terminal of the third resistor, having a second terminal coupled to the second terminal of the second resistor.

4. The power supply control circuit according to claim 1, wherein the charge and discharge circuit comprises:
a current source, configured to provide a first current;
a fourth capacitance, having a first terminal coupled to the current source, having a second terminal coupled to ground;
a second switch tube, having a control terminal coupled to the drive signal, having a first terminal coupled to the first terminal of the fourth capacitance, having a second terminal coupled to the second terminal of the fourth capacitance;
a transconductance amplifier circuit, having a first terminal coupled to the preset voltage, having a second terminal coupled to the power supply voltage; and
a second diode, having an anode coupled to the first terminal of the fourth capacitance, having a cathode coupled to the output terminal of the transconductance amplifier circuit.

5. The power supply control circuit according to claim 1, wherein the charge and discharge circuit comprises:
a transconductance amplifier circuit, having a first terminal coupled to the preset voltage, having a second terminal coupled to the power supply voltage;
a fourth capacitance, having a first terminal coupled to the output terminal of the transconductance amplifier circuit, having a second terminal coupled to ground;
a third diode, having an anode coupled to the second terminal of the fourth capacitance, having a cathode coupled to the first terminal of the fourth capacitance, and
a second switch tube, having a control terminal coupled to the drive signal, having a first terminal coupled to the first terminal of the fourth capacitance, having a second terminal coupled to the second terminal of the fourth capacitance.

6. The power supply control circuit according to claim 1, wherein the switch control circuit further comprises:
a second comparison circuit, having a first input terminal coupled to a current sampling signal, having a second input terminal coupled to a peak current sampling reference voltage, having an output terminal coupled to the reset terminal of the trigger circuit.

7. The power supply control circuit according to claim 5, wherein the charge and discharge circuit further comprises a maximum current limiting circuit coupled between the transconductance amplifier circuit and the fourth capacitor, the maximum current limiting circuit configured to control the charge current of the fourth capacitor so that the charge current is not greater than a preset current.

8. A flyback switching power supply, comprising a primary side circuit, a secondary side circuit and a transformer winding, and the primary side circuit comprising the power supply control circuit as claimed in claim 1.

9. A power supply control method, configured to control a power supply control circuit, the power supply control circuit comprising a boost circuit, the boost circuit comprising a first switch tube and a switch control circuit, the switch control circuit coupled to the control terminal of the first switch tube; the switch control circuit configured to control the first switch tube to start switching action when the input voltage is less than a preset voltage, and configured to control the first switch tube to stop switching action when the input voltage is greater than the preset voltage; the switch control circuit comprising a charge and discharge circuit and a first comparison circuit; the power supply control method comprising:
adjusting the charge current during charge and discharge process according to the preset voltage and the power supply voltage to control a charge and discharge voltage;
comparing the charge and discharge voltage with a feedback signal characterizing the input voltage, then outputting a comparison result signal; and
generating a driver signal to control the first switch tube according to the comparison result signal.

10. The power supply control method according to claim 9, the charge and discharge circuit comprising a current source, a fourth capacitance and a transconductance amplifier circuit, the fourth capacitance coupled to the current source, the output terminal of the transconductance amplifier circuit coupled to the current source and the fourth capacitance, wherein the power supply control method further comprises:
when the supply voltage is greater than the preset voltage, the first current output from the current source allowed to be diverted to the transconductance amplifier circuit, and when the supply voltage is less than the preset voltage, the output current from the transconductance amplifier circuit cut off.
